(19) United States
(12) Patent Application Publication
(10) Pub. No.: US 2025/0315733 A1
(43) Pub. Date: Oct. 9, 2025

(54) Scalable AI Control System Based on Micro AI Basic Units and Its Application Method

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/210,386

(22) Filed: May 16, 2025

(51) Int. Cl. G06N 20/00; H04L 9/08

(52) U.S. Cl. CPC G06N 20/00; H04L 9/0816

(57) ABSTRACT

A scalable AI control system is disclosed, based on modular AI micro-models that operate within embedded or distributed environments. Each micro-model is a compact, self-contained unit optionally configured to perform data-driven or symbolic reasoning, or a combination thereof. The invention includes secure containers with runtime enforcement, symbolic fallback mechanisms, and dynamic protocol adaptation. These micro-models may be deployed on hardware-independent platforms and are capable of autonomous or coordinated operation across mesh or non-mesh networks. The system enables flexible, verifiable control logic suitable for resource-constrained or adaptive embedded applications.

### CROSS-REFERENCE TO RELATED APPLICATIONS

### US Patent Documents

US 20240007547A1 January 2024 Li et al.

US 20240314200A1 September 2024 Selim et al.

US 20210021130A1 January 2021 FARROKHABADI et al.

US 20200236162A1 July 2020 BOUZON et al.

US 20200067789A1 February 2020 Khuti et al.

U.S. Pat. No. 11,580,428B2 February 2023 Guim Bernat et al.

U.S. Pat. No. 12,159,161B2 December 2024 Iniguez

US 2022/0278936 A1 September 2022 Zhang et al.

US 2020/0272456 A1 August 2022 Zhang et al.

US 2022/0264411 A1 August 2022 Zhang et al.

US 2021/0234567 A1 September 2021 LAM et al.

US 2022/0019845 A1 January 2022 Zhang et al.

### Other Publication

WO 2019209376 A1 October 2019 Torpy et al.

### BACKGROUND OF THE INVENTION

In recent years, artificial intelligence (AI) has become increasingly integrated into control systems across various sectors, including industrial automation, agriculture, healthcare, aerospace, and education. Many of these systems rely on centralized processing architectures or cloud-based models that, while powerful, introduce certain limitations. Specifically, such architectures can suffer from latency, lack of scalability, limited resilience, and increased dependency on continuous cloud connectivity.

Simultaneously, advances in mesh networking technologies have improved the reliability and range of wireless communication in distributed systems. However, existing mesh network solutions primarily focus on connectivity and data routing, without embedding intelligent decision-making or autonomous control capabilities at the edge of the network. As a result, most current solutions require external processors or centralized control logic to interpret data and make decisions, thereby limiting responsiveness and local autonomy.

There is a growing need for a new class of intelligent control systems that integrate distributed AI reasoning directly into the edge nodes. Such systems should be capable of operating independently, while also supporting collaboration with external AI platforms. Moreover, they should be dynamically scalable, self-organizing, and capable of functioning reliably in a wide range of environments, including those that may be disconnected from central servers or cloud infrastructures.

The present invention addresses these limitations by introducing a modular, topology-aware AI control system composed of intelligent Micro AI Basic Units. These units integrate localized AI inference, multi-protocol communication, and device-level control into a single scalable framework, enabling the construction of self-healing, collaborative, and efficient distributed AI networks.

### SUMMARY OF THE INVENTION

The present invention relates to a scalable artificial intelligence (AI) control system based on modular Micro AI Basic Units (μAI Units) and its associated method of implementation and operation. Each μAI Unit is a compact, self-contained computing element equipped with local AI reasoning capability, communication interfaces, control input/output ports, and energy management functionality. These units are designed to operate either independently or as part of a larger distributed AI system.

The invention incorporates a hybrid communication infrastructure that supports both wired and wireless protocols, including but not limited to Thread, Bluetooth, Bluetooth mesh, Wi-Fi, PLC and Ethernet. While some of these protocols operate at the application layer, the system architecture allows them to function effectively over underlying mesh capable or non-mesh capable networks, enabling robust and resilient communication across the network.

A topology-based (defined as node arrangement logic enabling dynamic, hierarchical AI cluster organization) scalable architecture enables μAI Units to dynamically organize into clusters, subnets, or partitions, forming adaptable and reconfigurable AI networks. The system allows for seamless integration of both locally deployed AI models and external large-scale AI models, facilitating collaborative decision-making between edge and cloud components.

The invention further provides an application methodology encompassing the steps of μAI Unit deployment, network configuration, dynamic scaling, and cross-model integration. The result is an AI control framework that is resilient, adaptable, and well-suited for deployment in a wide variety of application domains, including but not limited to industrial automation, agriculture, aerospace, healthcare, military systems, and smart educational environments.

### BRIEF DESCRIPTION OF DRAWINGS

FIG. 1: Overall System Structure Diagram

FIG. 2: Micro AI Basic Unit Functional Block Diagram

FIG. 3: Hybrid Mesh Network Communication Diagram

FIG. 4: Topology-Based Scalable Architecture Diagram

FIG. 5: AI Model Integration Diagram

FIG. 6: Application Scenario Diagram for Industrial Automation

FIG. 7: Application Scenario Diagram for Medical Monitoring

FIG. 8: Application Scenario Diagram for Agricultural Cultivation

FIG. 9: Application Scenario Diagram for Aerospace Systems

FIG. 10: Application Scenario Diagram for Educational and Cultural Systems

### DETAILED DESCRIPTION OF THE INVENTION

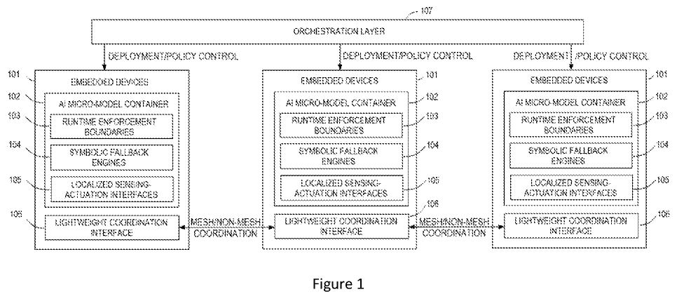

FIG. 1 illustrates the overall system structure of the scalable AI control system. The architecture comprises multiple Micro AI Basic Units (μAI Units), each connected to various end devices such as sensors and actuators. These μAI Units are interconnected via a hybrid mesh communication network that facilitates robust data exchange and control. The system optionally interfaces with an external AI model server, enabling collaborative processing between local and remote intelligence layers. A user interface or control center is also shown, providing human operators access to system status and configurations.

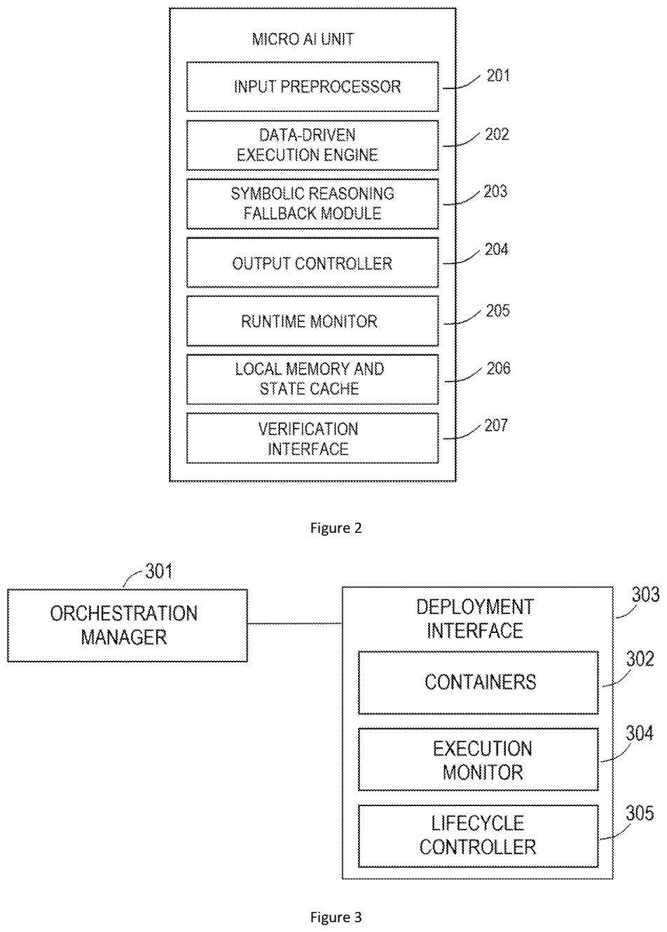

FIG. 2 presents the functional block diagram of a Micro AI Basic Unit. Each μAI Unit includes a processor or controller, local memory, and an integrated AI reasoning engine. Communication interfaces support various protocols such as Thread, Wi-Fi, Bluetooth, Bluetooth mesh, PLC (Power Line Communication) and Ethernet. The unit also comprises analog and digital input/output interfaces for sensor and actuator connections, along with an energy management module to enable operation in energy-constrained environments. This modular structure allows each μAI Unit to operate independently or in concert with others in a distributed configuration.

FIG. 3 illustrates the hybrid network communication diagram, including mesh and non-mesh networks. μAI Units are arranged in a mesh and bus topologies, communicating over multiple protocols including Thread, Bluetooth, Bluetooth mesh, Wi-Fi, PLC and Ethernet. The diagram demonstrates how data is routed dynamically across the network using self-healing, multi-hop paths to ensure resilience and continuity. The communication infrastructure enables both low-latency local control and integration with cloud-based systems via MQTT or other application-layer protocols operating over IP transport layers.

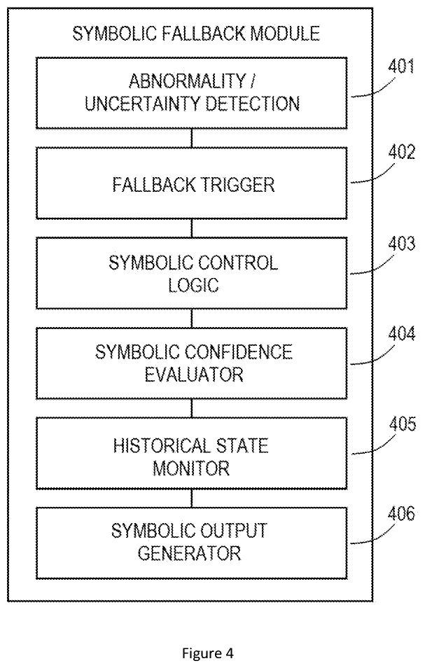

FIG. 4 depicts the topology-based (defined as node arrangement logic enabling dynamic, hierarchical AI cluster organization) scalable architecture. μAI Units are shown forming logical clusters or subnets, with each cluster capable of operating semi-autonomously. A coordinator or master node may manage inter-cluster communication. The system supports multi-partition configurations with separate encryption keys, allowing secure and isolated communication between different functional zones. The topology is designed to facilitate dynamic growth, fault tolerance, and hierarchical AI deployment.

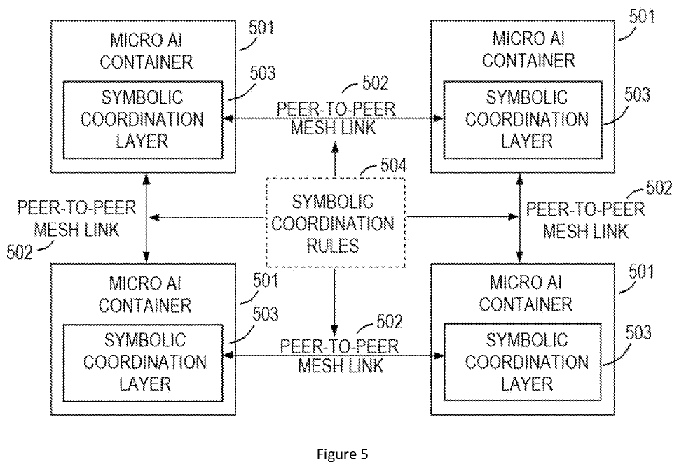

FIG. 5 demonstrates the AI model integration structure. Local AI models embedded within μAI Units perform real-time data analysis and decision-making at the edge. These local models can interact with an external AI model server for advanced inference, learning updates, or centralized optimization. The integration pathway is bidirectional, enabling not only data offloading but also remote command reception and adaptive model synchronization.

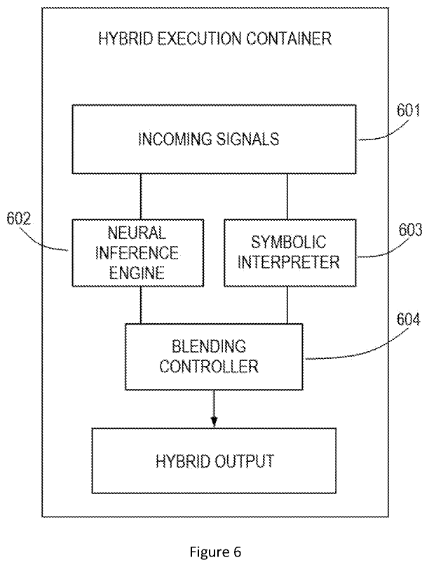

FIG. 6 shows an application scenario in the context of industrial automation. μAI Units are deployed across various machines and equipment, interfacing with local sensors and actuators. Each unit makes autonomous decisions based on sensor input, while maintaining networked coordination with other units. A central dashboard aggregates data and control status, allowing operators to monitor and intervene when necessary.

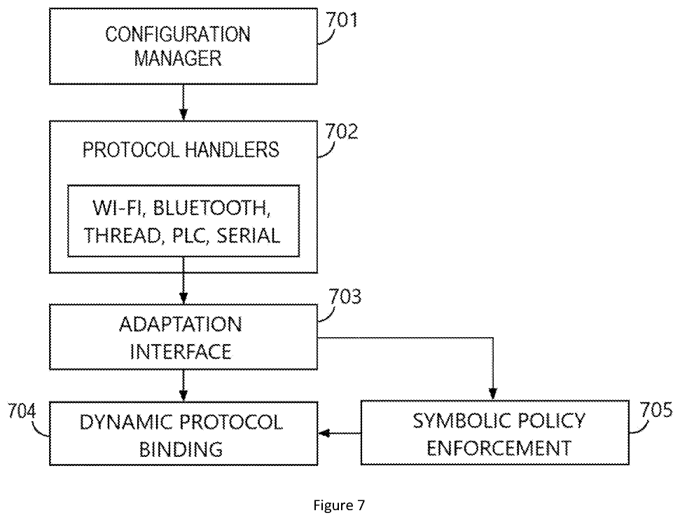

FIG. 7 illustrates the use of the system in a medical monitoring environment. μAI Units are connected to patient monitoring devices, enabling real-time health data collection and localized AI analysis. Alerts or anomalies detected by the μAI Unit can be transmitted to a central medical server or staff dashboard. The decentralized architecture ensures continued monitoring even in case of temporary network outages.

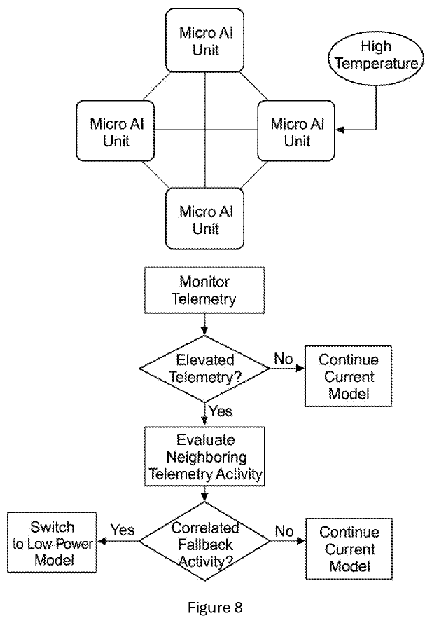

FIG. 8 portrays an agricultural deployment scenario. μAI Units are positioned across different zones of a cultivation site, managing irrigation systems, environmental sensors, and lighting control. Data collected from the field is processed locally, and actuation commands are executed in real time. The system can also relay field data to a cloud-based AI service for higher-level optimization, such as growth-stage-specific fertigation planning or predictive pest control.

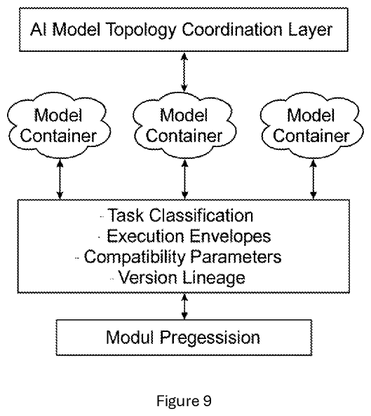

FIG. 9 provides a diagram of the system applied in aerospace environments. μAI Units are embedded within various subsystems of an aircraft or spacecraft, including navigation, propulsion, life support, and communication. The units operate collaboratively and communicate with a ground-based mission control center. Their distributed nature improves redundancy, system resilience, and mission safety.

FIG. 10 demonstrates the deployment of the system in educational and cultural environments. μAI Units are embedded within interactive exhibits or classroom tools, processing data from sensors and learning interfaces. These units manage personalized content delivery and adapt to user input in real time. Remote servers may synchronize content updates or analyze user engagement metrics, enhancing educational outcomes and visitor experiences.

1. A scalable control system comprising:
at least one embedded hardware unit;
at least one AI micro-model container instantiated on said embedded hardware unit, wherein the AI micro-model container is configured to execute a data-driven model, a symbolic reasoning model, or a combination thereof;
a runtime boundary module within said container that enforces bounded execution and verifiable operation;
a symbolic fallback engine embedded within said container, configured to assume control upon detection of inference uncertainty or runtime anomalies;
wherein the system is configured to operate in a mesh or non-mesh network environment and supports deployment across a hardware-independent platform using a CPU, GPU, FPGA, ASIC, or other equivalent or similar functionality microprocessor.

2. The system of claim 1, wherein the symbolic fallback engine comprises a rule-based interpreter selected from declarative logic, state machines, or procedural sequences.

3. The system of claim 1, wherein the AI micro-model container includes a local memory cache for state history retention and context-aware decision-making.

4. The system of claim 1, further comprising a container orchestration engine optionally configured to manage model selection, deployment, signature verification, and lifecycle enforcement.

5. The system of claim 1, wherein each AI micro-model container includes a blending controller that merges symbolic and neural outputs based on confidence thresholds or execution time constraints.

6. The system of claim 1, further comprising a symbolic coordination module that enables distributed control behaviors via peer-to-peer communication among micro-models.

7. The system of claim 1, wherein the AI micro-model is optionally configured to operate in a non-networked standalone mode with fallback coordination emulated locally.

8. The system of claim 1, wherein the symbolic fallback logic is precompiled and selectively activated based on a detected uncertainty threshold or runtime policy condition.

9. The system of claim 1, further comprising a mesh gateway device configured to manage symbolic handoffs between AI micro-model containers across the network.

10. A method for deploying a scalable AI control system based on AI micro-models, the method comprising:
selecting at least one AI micro-model based on functional requirements and resource constraints;
instantiating the AI micro-model within a secure container on an embedded device;
monitoring runtime behavior using an embedded verification interface;
executing symbolic reasoning logic in place of, or in combination with, data-driven inference logic;
adapting control output and device communication through a dynamic protocol binding interface;
wherein the method supports alternative or combined use of symbolic and neural execution, and is not limited to a specific platform, protocol, or model type.

11. The method of claim 10, wherein symbolic fallback is triggered based on runtime anomaly detection, low-confidence inference, or external signal loss.

12. The method of claim 10, further comprising performing cryptographic verification of an AI micro-model container to validate integrity prior to or during activation.

13. The method of claim 10, wherein the protocol adaptation interface supports dynamic switching between at least two communication protocols without manual intervention.

14. The method of claim 10, wherein fallback logic includes constraint satisfaction mechanisms for bounded search and decision pruning.

15. The method of claim 10, further comprising real-time adaptation of execution policy based on sensor input classification.

16. An AI micro-model container, comprising:
an input preprocessor configured to normalize or extract signal features;
a compact neural inference engine;
a symbolic logic engine configured to operate in fallback or cooperative mode with the neural inference engine;
a runtime monitor enforcing container integrity and bounded resource usage;
a protocol adaptation interface configured to bind to at least one of Ethernet, Wi-Fi, Bluetooth, PLC, Thread or Serial communication standards;
wherein said container is deployable on a CPU, GPU, or other microprocessor configured to execute embedded model logic, and is capable of operating independently or within a distributed symbolic coordination layer.

17. The AI micro-model container of claim 16, wherein the symbolic logic engine is optionally configured to perform explainable reasoning for audit or regulatory inspection.

18. The AI micro-model container of claim 16, wherein the protocol adaptation interface is governed by symbolic enforcement policies that restrict communication based on runtime context.

19. The AI micro-model container of claim 16, wherein the container includes a telemetry interface for reporting operational status and fallback events.

20. The AI micro-model container of claim 16, wherein the neural inference engine is optionally compressed or quantized for embedded deployment.
